(19) United States
(12) Patent Application Publication
(10) Pub. No.: US 2024/0017574 A1
(43) Pub. Date: Jan. 18, 2024

(54) VEHICLE TIRE COMPRISING A HATCHED SURFACE, VULCANIZATION MOLD AND PRODUCTION METHOD

(71) Applicant: Continental Reifen Deutschland GmbH, Hannover (DE)

(72) Inventors: Stefan Rittweger, Garbsen (DE); Juraj Jurco, Hannover (DE)

(73) Assignee: Continental Reifen Deutschland GmbH, Hannover (DE)

(21) Appl. No.: 18/255,806

(22) PCT Filed: Nov. 25, 2021
(86) PCT No.: PCT/DE2021/200201

§ 371 Date: Jun. 2, 2023

(30) Foreign Application Priority Data
Dec. 2, 2020 (DE) 10 2020 215 187.3

(51) Int. Cl. B60C 13/00; B29D 30/06; B29D 30/72

(52) U.S. Cl. CPC B60C 13/001; B29D 30/0606; B29D 30/72; B29D 2030/0612; B29D 2030/726

(57) ABSTRACT

The invention relates to a vehicle tire (1) with sidewalls (2) and a tread (3) and with at least one hatched area (4) on at least one of the sidewalls (2) and/or the tread (3), wherein the hatched area (4) has elongated hatching ribs (5) which are arranged largely parallel to one another. The invention also relates to a vulcanization mold and to a method for producing the vehicle tire.

The object is to influence the contrast effect in an even more targeted fashion and to further increase the contrast effect. It is also intended to make it possible for the tire to be produced reliably by means of a vulcanization mold.

This is achieved by each hatching rib (5) having branches (7), wherein in each case precisely one short transverse elevation (6) branches off from each branch (7) of the branches, and by the short transverse elevations (6) all branching off on a same first side (9) of the hatching ribs (5) and ending in a free end (8).

The invention relates to a vehicle tire with sidewalls and a tread and with at least one hatched area on at least one of the sidewalls and/or on the tread, wherein the hatched area has elongated hatching ribs which are arranged largely parallel to one another. The invention also relates to a vulcanization mold and to a method for producing the vehicle tire.

Such hatched areas are generally imprinted into the tire in the course of the vulcanization of the tire by means of a shape-imparting vulcanization mold which has a negative contour of the hatched area. A structured surface of an already vulcanized tire can however also be achieved by material removal, for example by means of engraving, or by an additive process.

Such hatched areas are generally imprinted into the tire in the course of the vulcanization of the tire by means of a shape-imparting mold area of a vulcanization mold which has a negative contour of the hatched area. A structured surface of an already vulcanized tire can however also be achieved by material removal, for example by means of engraving, or by an additive process. Such hatched areas are known. On the tire sidewall and/or on the tread, they are used, for example, to realize a marking. A marking may here include images, characters, company names, company logos, identifiers, areas, etc. The hatched area may here be part of the marking and/or may completely or partially surround the latter.

The scattering of light on the flanks of the hatching ribs reduces the reflection of the light on the surface of the tire, which changes the brightness effect. In general, surface regions provided with transverse elevations appear darker than substantially smooth surface regions that are free from such elevations. This make it possible to realize a contrast in the inherently monochrome surface of the tire, in particular of the sidewall and/or of the tread. Representations of markings can be made more clearly visible as a result.

For example, EP 2483088 A1 discloses a vehicle tire which, on its sidewall, has a multiplicity of hatching ribs, arranged largely parallel to one another, for a high-contrast surface design and accentuation of a marking.

However, the design possibilities with such a hatching are limited.

The object is therefore to influence the contrast effect in an even more targeted fashion, and to further increase the contrast effect. It is also intended to make it possible for the tire to be produced reliably by means of a vulcanization mold.

This is achieved by a vehicle tire as claimed in claim 1, a vulcanization mold as claimed in claim 14, and a production method as claimed in claim 15.

The vehicle tire according to the invention is characterized in that each hatching rib of the hatching ribs has branches, wherein in each case precisely one short transverse elevation branches off from each branch of the branches and in that the short transverse elevations all branch off on a same first side of the hatching ribs and end in a free end.

Each hatching rib thus forms a hatching element, like a comb in plan view, with the transverse elevations branching off from it on the first side. The hatching ribs and the short transverse elevations are here in each case designed as an elevation from a hatching base of the hatched area. Each hatching rib has branches, wherein in each case precisely one of the short transverse elevations branches off from each branch, i.e. precisely one short transverse elevation merges into each branch of a hatching rib. The short transverse elevations here all branch off on the same first side of the hatching ribs, i.e. they all merge into the respective hatching rib from the same first side.

The short transverse elevations end in free ends. The short transverse elevations are thus free of further branches and/or intersections with further elevations from the hatching base. Each short transverse elevation branches off in each case from precisely one hatching rib and ends before the next hatching rib. The free ends of the short transverse elevations scatter the light additionally in different directions and there is further shadow between the free ends and the adjacent next hatching rib.

The transverse elevations of all the hatching ribs branch off on the same first side of the hatching ribs and extend as elevations from the hatching base as far as their free end. This results in a sequence, in a direction transverse to a direction of longitudinal extent of the hatching ribs, consisting of a hatching rib, a region with short transverse elevations branching off from the hatching rib, the next hatching rib, a region with short transverse elevations branching off from the next hatching rib, etc. Targeted control of the contrast effect is enabled as a result.

It has been shown that hatching ribs with branching-off short transverse elevations produce a significantly stronger contrast effect than hatching ribs which are free from such short transverse elevations which branch off into branches. The additional flanks of the short transverse elevations increase the scattering, the multiple reflection, and the absorption of light that is incident on the hatched area.

In addition, flanks of the hatching ribs facing the first side of the hatching ribs are interrupted by the short transverse elevations, which further increases the contrast. In contrast, flanks facing away from the first side of the hatching ribs are free of interruptions, in particular free of interruptions by merging elevations.

The short transverse elevations also create additional shadow effects which, particularly on the black rubber of the vehicle tire, give rise to a clear accentuation of the hatched area in relation to the surrounding in particular smooth surface regions.

By means of the hatching ribs with branching-off short transverse elevations according to the invention, the contrast effect can thus be influenced and improved in an even more targeted manner.

A further advantage consists in the fact that a mold surface having a mold negative of such a hatched area can be produced particularly reliably in particular by means of laser engraving. The mold negative of the branching-off short transverse elevations can especially be produced with a more reliable degree of precision. In particular, the width of the mold negative of the short transverse elevations branching off on just the first side can be controlled reliably by means of laser engraving. Thus, the width of the short transverse elevations of the hatched area branching off on just the first side can also be controlled reliably, as a result of which the contrast effect on the tire can be ensured reliably.

If elevations, in particular hatching ribs or short transverse elevations, are arranged largely parallel to one another, within the sense of the application this means that directions of the longitudinal extent of respective adjacent elevations of the elevations enclose an angle of no more than 5° with each other.

An advantageous embodiment is provided by the short transverse elevations of at least one hatching rib of the hatching ribs being arranged largely parallel to one another.

As a result, a high density of short transverse elevations is enabled, as a result of which the contrast effect is further intensified. By virtue of the same orientation of the transverse elevations, at the same time a negative contour of the hatched area thus configured can be created in a mold area of a vulcanization mold particularly efficiently by means of engraving, in particular laser engraving.

A particularly uniform contrast effect results if the short transverse elevations of all the hatching ribs are arranged largely parallel to one another.

A further advantageous embodiment is provided by the branches of at least one hatching rib of the hatching ribs being arranged equidistantly.

A uniform contrast effect can be obtained as a result. The equidistant arrangement also enables efficient production of a negative contour of the hatched area thus configured in a mold face of a vulcanization mold by means of engraving, in particular laser engraving.

A particularly uniform contrast effect results if all the hatching ribs are designed in this way.

A further advantageous embodiment is provided by the branches of at least one hatching rib of the hatching ribs and the branches of a hatching rib adjacent to the at least one hatching rib being arranged offset to one another.

As a result, the short transverse elevations can be distributed particularly uniformly over the hatched area. This also enables efficient production of a negative contour of the hatched area thus configured in a mold face of a vulcanization mold by means of engraving, in particular laser engraving.

A further advantageous embodiment is provided by a direction of the longitudinal extent of at least one hatching rib of the hatching ribs enclosing an angle of 45° to 90°, preferably of 60° to 90°, particularly preferably of largely 90°, with the respective direction of the longitudinal extent of the respective branching-off short transverse elevation.

The angle influences the local density distribution on inclined flanks adjacent to a branch. In the case of an angle of less than 45°, however, the demolding of the tire is made more difficult. An angle of 60° to 90° allows an improved contrast effect with simultaneously good demoldability from a mold face having a negative contour of the hatched area thus configured. The demoldability is further improved in the case of an angle of 90°.

It is also expedient if all the short transverse elevations of a hatching rib enclose the same angle with the respective hatching rib. This limits the number of directions to be engraved in order to generate a mold negative for this hatching rib. This advantage is further intensified if all the hatching ribs are configured in this way.

A further advantageous embodiment is provided by the short transverse elevations of at least one hatching rib of the hatching ribs having a length L of 0.2 mm to 0.5 mm, preferably of 0.25 mm to 0.40 mm, particularly preferably of 0.25 mm to 0.32 mm.

The length L of the short transverse elevations can be measured from a ridge line of the hatching rib, which runs along a ridge or the center of a ridge of the hatching rib, as far as the free end of the short transverse elevation, measured at a third of a height H of the hatching rib and measured parallel to a level of the hatching base.

The contrast effect of short transverse elevations with a length L of less than 0.2 mm is limited. A length L of 0.2 mm to 0.5 mm enables advantageous influencing of the contrast effect with a limited length. At the same time, a corresponding negative contour of a mold area of a vulcanization mold can be produced reliably by laser engraving. A length of 0.25 mm to 0.40 mm, particularly preferably of 0.25 mm to 0.32 mm, has proved to be particularly advantageous here. The advantage is intensified if several, preferably all, hatching ribs are designed in this way. Such a length L enables good demoldability of the tire from a mold area having a negative contour of the hatched area thus configured.

A further advantageous embodiment is provided by the branches of at least one hatching rib of the hatching ribs having a first center spacing of 0.2 mm to 0.4 mm, preferably of 0.25 mm to 0.30 mm.

Such a first center spacing of the branches of a hatching rib enables a clear distinction of the short QR code with a simultaneous dense arrangement of the transverse elevations. The first center spacing can be measured parallel to a level of the hatching base. A negative contour of the hatched area thus configured in a mold area of a vulcanization mold can be produced reliably and precisely by means of laser engraving and the mold area can be cleaned effectively. Such a tire can be effectively removed from the vulcanization mold.

A further advantageous embodiment is provided by the hatching ribs being arranged with a second center spacing of 0.4 mm to 1.0 mm, preferably of 0.5 mm to 0.7 mm, particularly preferably of 0.55 mm to 0.60 mm.

A second center spacing between adjacent hatching ribs of at least 0.4 mm, preferably at least 0.5 mm, particularly preferably at least 0.55 mm, enables sufficient space between adjacent hatching ribs for the arrangement of the transverse elevations. A second center spacing between adjacent hatching ribs of no more than 1.0 mm, preferably no more than 0.7 mm, particularly preferably no more than 0.60 mm, enables an arrangement of the hatching ribs which is sufficiently dense for the contrast effect. Such a second center spacing enables an improved contrast effect with a simultaneously moderate manufacturing complexity of the negative contour of the hatched area thus configured in a mold area of a vulcanization mold by means of engraving, in particular laser engraving. The second center spacing of the hatching ribs can be measured between ridge lines of the hatching ribs, wherein the ridge lines in each case run along a ridge or the center of a ridge of the respective hatching rib and wherein the second center spacing is measured parallel to a level of the hatching base. The advantage is intensified if several, preferably all, hatching ribs are designed in this way.

A further advantageous embodiment is provided by at least one hatching rib of the hatching ribs having a height H of 0.1 mm to 0.8 mm, preferably of 0.2 mm to 0.5 mm, particularly preferably of 0.25 mm to 0.35 mm.

The height H of a hatching rib may be the height averaged along the longitudinal extent of the hatching rib. Heights can be measured relative to a level of the hatching base of the hatched area.

Mean values generally correspond to the arithmetic mean value.

As a result, favorable dimensioning is achieved that assists producibility. A negative contour of the hatched area thus configured in a mold area of a vulcanization mold can be produced by means of engraving, in particular laser engraving.

The hatched area is particularly advantageous if several, preferably all, hatching ribs have a corresponding height H. The advantage is intensified if several, preferably all, hatching ribs are designed in this way.

It is expedient if the hatching rib and the branching-off short transverse elevation have a same height at a branch.

A further advantageous embodiment is provided by at least one hatching rib of the hatching ribs having mutually opposite flanks which enclose an angle of at least 50°, preferably of 55° to 65°, with one another.

Such flank angles exhibit a good contrast effect. A negative contour of the hatched area thus configured in a mold surface of a vulcanization mold can be created, for example, by means of engraving, in particular laser engraving or material-removal engraving.

A particularly advantageous hatched area results if the mutually opposite flanks have such an angle over a height extent which corresponds to at least one quarter of the height H of the hatching rib. The advantage is intensified if several, preferably all, hatching ribs are designed in this way.

A further advantageous embodiment is provided by at least one hatching rib of the hatching ribs and/or at least one short transverse elevation of the short transverse elevations having mutually opposite flanks which enclose an angle of 2° to 10°, preferably of 6° to 8°, with one another.

Multiple reflection and thus an improved contrast effect can be achieved with such a steep flank angle. A negative contour of the hatched area thus configured in a mold surface of a vulcanization mold can be created reliably by means of laser engraving of the mold die. A particularly advantageous hatched area results if the mutually opposite flanks enclose such an angle over a height extent which corresponds to at least one quarter of the height H of the hatching rib. The advantage is also or additionally intensified if several, preferably all, hatching ribs are formed in this way.

It is preferable if all the short transverse elevations of a hatching rib of the hatching ribs have mutually opposite flanks which enclose an angle of 2° to 10°, preferably of 6° to 8°, with one another.

In one expedient embodiment, the hatching ribs each have mutually opposite flanks which enclose an angle of at least 50° with one another, and the short transverse elevations each have mutually opposite flanks which enclose an angle of 2° to 10°, preferably of 6° to 8°, with one another.

In another expedient embodiment, both the hatching ribs and the short transverse elevations each have mutually opposite flanks which enclose an angle of 2° to 10°, preferably of 6° to 8°, with one another.

A further expedient embodiment is provided by at least one hatching rib of the hatching ribs and/or at least one short transverse elevation of the short transverse elevations having mutually opposite flanks which enclose an angle of 2° to 10°, preferably of 6° to 8°, with one another, and by the respective elevation here having a width of 0.08 mm to 0.13 mm, preferably of 0.1 mm. The width can here be measured at one third of the height of the hatching rib or of the hatching rib belonging to the short transverse elevation.

A further advantageous embodiment is provided by at least one hatching rib of the hatching ribs and/or at least one short transverse elevation having a flank which has a convexly curved and/or a linear and/or a concavely curved and/or a stepped and/or a bent and/or a structured region.

As a result, the contrast effect can be influenced in an even more targeted fashion and the contrast effect can be further improved. A corresponding negative contour in a mold surface of a vulcanization mold can be created, for example, by means of engraving, in particular laser engraving. The advantage of the hatched area thus configured is intensified if several, preferably all, crossed hatching ribs and/or short transverse elevations are designed in this way.

It is particularly advantageous if the correspondingly shaped region extends over a height extent which corresponds to at least one quarter of the height H of the hatching rib of the hatching element.

The hatching ribs and/or the short transverse elevations may transition into the hatching base in a bend or in a curved fashion. The cross-section may be designed as symmetrical.

The hatching ribs and/or the short transverse elevations may have a flattened ridge. The ridge may comprise a plateau with a width of 0.03 mm to 0.06 mm. The ridge may also have irregularities in height which amount to a maximum of 5% of the height H.

A further advantageous embodiment is provided by the vehicle tire having several hatched areas which are arranged in such a way that they represent a machine-readable code, preferably a two-dimensional code, particularly preferably a QR code.

Thus, a high-contrast QR code can be provided in a simple fashion on the surface of the vehicle tire. The hatched areas can here represent the usually dark, in particular black, areas of the machine-readable code. The usually light, in particular white, areas of the machine-readable code may have a different surface structure from the surface structure of the hatched area, in particular a largely smooth area.

Irrespective of the embodiment, the hatching base of the hatched area may be configured such that it separates adjacent crossed hatching ribs and/or adjacent short transverse elevations from one another. A hatching base which is configured as largely flat is preferred here.

An expedient embodiment is provided by the short transverse elevations of at least one hatching rib continually sloping from the branches to the hatching base. As a result, the demoldability is further improved at the same time as an advantageous supporting effect of the short transverse elevations.

The ridges of the hatching ribs and/or the short transverse elevations of the hatched area may be designed as lowered, elevated, or at the same level relative to a tire surface surrounding the hatched area.

In one preferred embodiment, the hatched area is designed on one of the sidewalls of the vehicle tire. An advantageous contrast effect for emphasizing markings is particularly important on the side wall.

According to a further preferred embodiment, the hatched area is designed on the tread of the vehicle tire. The hatched area may in particular also be applied to groove flanks and/or groove bases of grooves running in the tread, or at the tread outlet, i.e. at the shoulder flanks running outside the ground contact area to the sidewalls, or on the outer surface of the tread, i.e. on the tread that comes into contact with the ground.

The tire is preferably a pneumatic vehicle tire. The tire is particularly preferably a tire for a car. It may, however, also be a different vehicle pneumatic tire, in particular for a bicycle, a van, an SUV, a light truck, a commercial vehicle, a motorcycle, and/or a bus.

The invention also comprises a vulcanization mold for shape-imparting vulcanization of the vehicle tire according to the invention. The vulcanization mold here has a mold area which has a negative contour of a hatched area, wherein the hatched area has elongated hatching ribs which are arranged largely parallel to one another. The vulcanization mold is characterized in that each hatching rib has branches, wherein in each case precisely one short transverse elevation branches off from each branch, and in that the short transverse elevations all branch off on a same first side of the hatching ribs and end in a free end.

Such a vulcanization mold enables reliable production of the vehicle tire according to the invention. The hatched area is here optimized to the effect that the negative contour of the hatched area can be produced reliably by means of laser engraving and hence the hatched area can be produced in a shape-imparting fashion on the tire surface in the course of the vulcanization process and removed from the mold reliably, and that the mold area having the negative contour can be cleaned effectively.

The invention furthermore relates to a method for producing a vehicle tire according to the invention. The method comprises at least the following steps:
a) engraving a negative contour of a hatched area into a mold area of a vulcanization mold for the shape-imparting vulcanization mold of a vehicle tire by means of laser engraving, wherein the hatched area has elongated hatching ribs which are arranged largely parallel to one another, wherein each hatching rib has branches, wherein in each case precisely one short transverse elevation branches off from each branch, and wherein the short transverse elevations all branch off on a same first side of the hatching ribs and end in a free end,
b) providing a tire blank and positioning the tire blank in the vulcanization mold having the mold area,
c) shape-imparting vulcanization of the tire blank by means of the vulcanization mold having the mold area, as a result of which the hatched area is imprinted into an outer area of the vehicle tire, in particular a sidewall and/or a tread of the vehicle tire.

Reliable production of the vehicle tire according to the invention is enabled as a result. The negative contour of the hatched area is here optimized to the effect that it can be produced reliably by means of laser engraving and hence the hatched area can be produced in a shape-imparting fashion in the course of the vulcanization process and removed from the mold reliably, and that the mold area having the negative contour can be cleaned effectively. The hatched area is preferably arranged on the sidewall of the tire.

Further features, advantages, and details of the invention will now be described in more detail on the basis of the drawings, which schematically show exemplary embodiments of the invention. In the drawings:

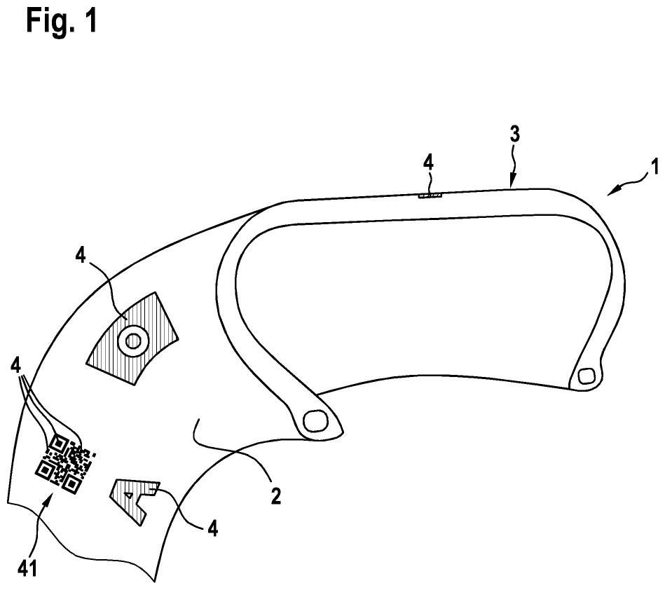

FIG. 1 shows a vehicle tire 1 having a hatched area;

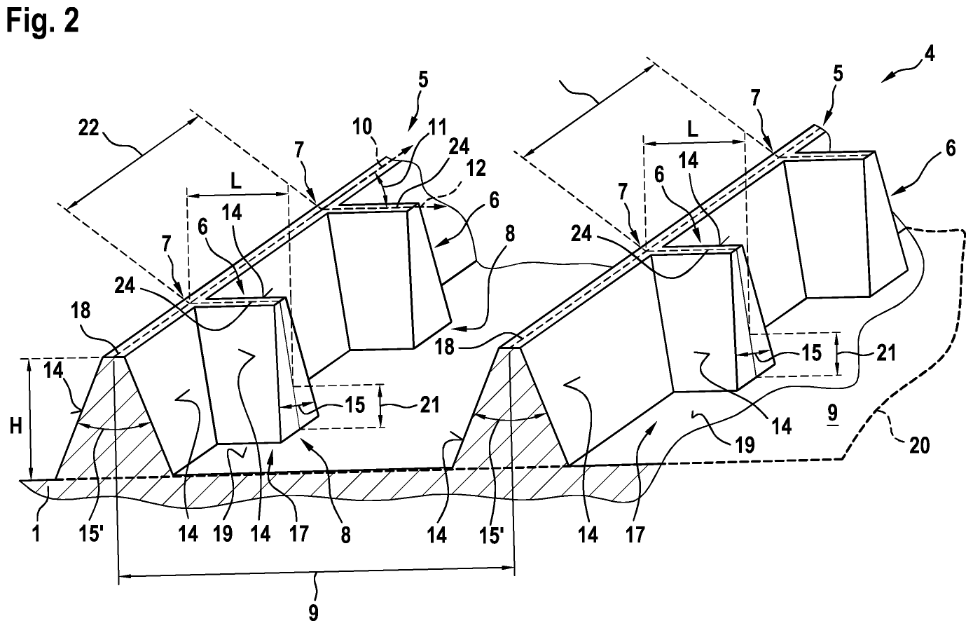

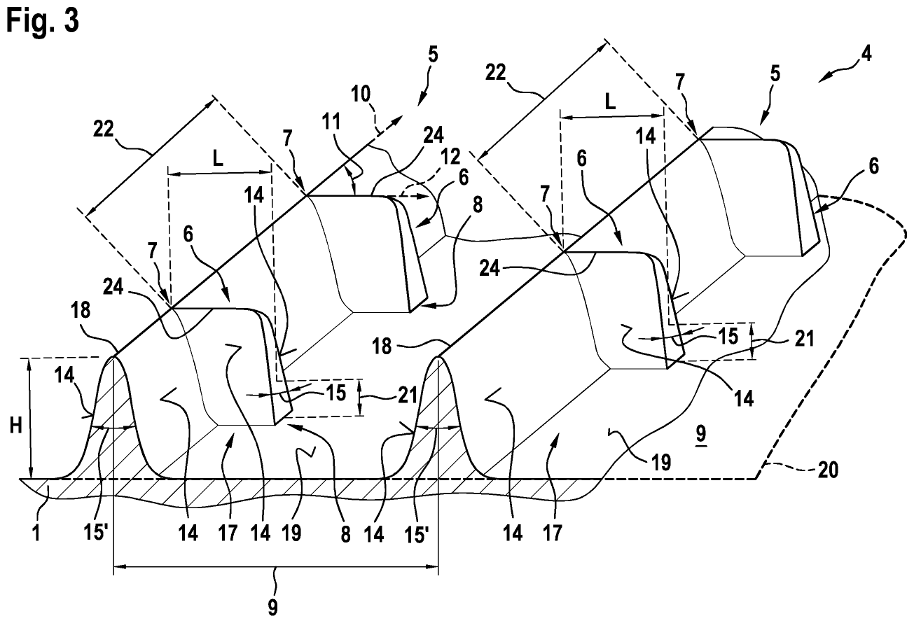

FIGS. 2 and 3 each show a hatched area;

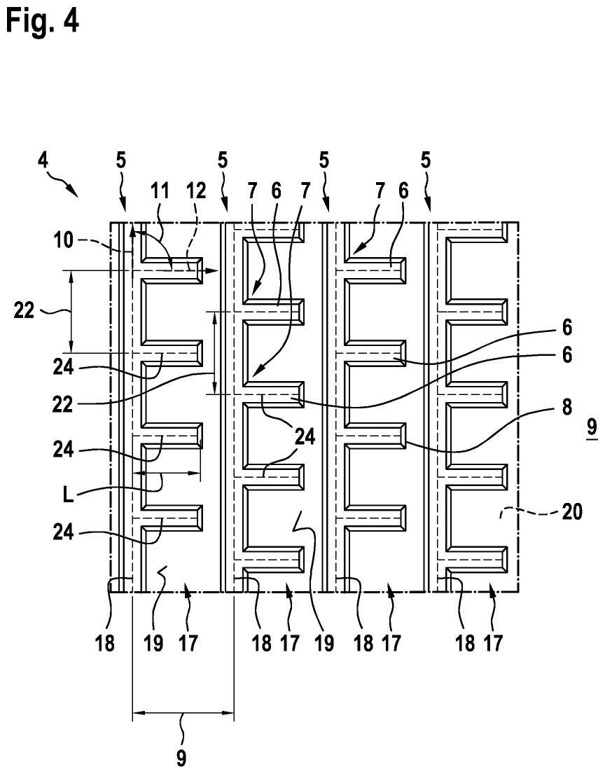

FIG. 4 shows a plan view of a hatched area,

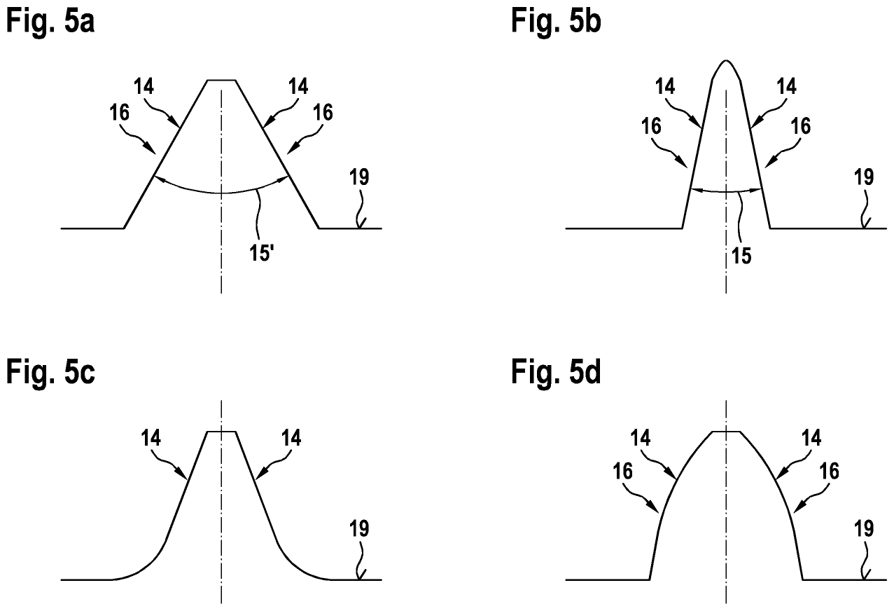

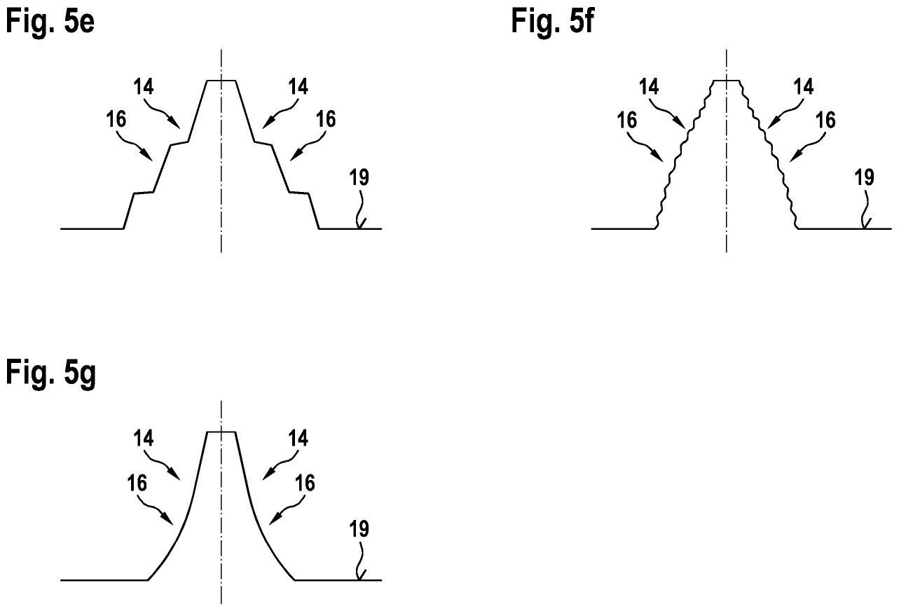

FIG. 5 shows exemplary embodiments of cross-sections.

FIG. 1 shows a vehicle tire 1 with sidewalls 2 and a tread 3 and with at least one hatched area 4 on at least one of the sidewalls 2 and/or on the tread 3. In the case of an arrangement on the tread 3, the hatched area may in particular also be applied to groove flanks and/or groove bases of grooves running in the tread 3, or at the tread outlet, i.e. at the shoulder flanks running outside the ground contact area to the sidewalls, or on the outer surface of the tread, i.e. on the tread which comes into contact with the ground. The hatched area 4 is preferably applied to at least one of the sidewalls 2. The tire is preferably a pneumatic vehicle tire, in particular for a car. It may, however, also be a different vehicle tire, in particular for a bicycle, a van, an SUV, a light truck, a commercial vehicle, a motorcycle, and/or a bus.

The hatched area 4 has elongated hatching ribs 5 which are arranged largely parallel to one another. Each hatching rib 5 has two branches 7, wherein in each case precisely one short transverse elevation 6 branches off from each branch 7 of the branches. The short transverse elevations 6 here all branch off on a same first side 9 of the hatching ribs and end in a free end 8.

Such hatched areas 4 are exceptionally well suited for representing a code 41, in particular a two-dimensional code such as, for example, a QR code 41. The usually dark areas of the code may here be designed as hatched areas 4.

The ridges of the hatching ribs 5 with the ridge lines 18 and/or the ridges of the short transverse elevations 6 with the ridge lines 24 may be designed as lowered, elevated, or at the same level relative to a tire surface surrounding the hatched area.

Two design variants of such a hatched area 4 are shown in FIGS. 2 and 3.

The branches 7 of each hatching rib 5 can be clearly seen. In each case precisely one short transverse elevation 6 branches off from each branch 7. The short transverse elevations 6 of all hatching ribs here branch off on a same first side 9 of the hatching ribs and extend in each case as an elevation from a hatching base 19 as far as their free end 8. Each hatching rib 5 thus forms a hatching element, like a comb in plan view, with the short transverse elevations 6 branching off from it on the first side 9. This thus results in a sequence, in a direction transverse to a direction of longitudinal extent of the hatching ribs 5, consisting of a hatching rib 5, a region 17 with short transverse elevations 6 branching off from the respective hatching rib 5, the next hatching rib 5, the next region 17 with short transverse elevations 6 branching off from the respective hatching rib 5, etc. The hatching ribs and the short transverse elevations 6 are here designed in each case as an elevation from the hatching base 19 of the hatched area 4.

The short transverse elevations 6 of all the hatching ribs 5 each end in a free end 8. The short transverse elevations 6 are thus free of further branches and/or intersections with an elevation from the hatching base 19. Each short transverse elevation 6 thus branches off from precisely one hatching rib 5 and ends before the next hatching rib 5.

Flanks 14 of the hatching ribs facing the first side 9 of the hatching ribs 5 are interrupted by the short transverse elevations 6, which further increases the contrast. In contrast, flanks 14 facing away from the first side 9 of the hatching ribs are free of interruptions.

The short transverse elevations 6 of at least one hatching rib 5, in particular of all the hatching ribs, of the hatching ribs are arranged largely parallel to one another. The branches 7 of at least one hatching rib 5, in particular of all the hatching ribs, of the hatching ribs are arranged equidistantly. The branches 7 of a hatching rib 5 of the hatching ribs and the branches 7 of a hatching rib 5 adjacent to the hatching rib 5 are arranged offset relative to one another.

A longitudinal extent direction 10 of at least one hatching rib 5 of the hatching ribs encloses an angle 11 of 45° to 90°, preferably of 60° to 90°, particularly preferably of largely 90°, with the respective longitudinal extent direction 12 of the branching-off short transverse elevations 6. An angle 11 of 90° is illustrated.

The short transverse elevations 6 of at least one hatching rib 5 of the hatching ribs have a length L of 0.2 mm to 0.5 mm, preferably of 0.25 mm to 0.40 mm, particularly preferably of 0.30 mm to 0.35 mm. The length L may here be measured from a ridge line 18 of the hatching rib 5 as far as the free end 8 of the short transverse elevation 6, measured at one third 21 of a height H of the hatching rib 5 and measured parallel to a level 20 of the hatching base 19 of the hatched area 4. The ridge line 18 here runs, as illustrated in FIG. 3, along the ridge of the hatching rib 5 or, in the case of a flattened ridge, along the center of the ridge, as illustrated in FIG. 2.

The branches 7 of at least one hatching rib 5 of the hatching ribs have a first center spacing 22 of 0.2 mm to 0.4 mm, preferably of 0.25 mm to 0.30 mm. The hatching ribs 5 are arranged with a second center spacing 23 of 0.4 mm to 1.0 mm, preferably of 0.5 mm to 0.7 mm, particularly preferably of 0.55 mm to 0.60 mm. The second center spacing 23 of the hatching ribs may be measured between the ridge lines 18 of the hatching ribs 5, in each case measured parallel to the level 20 of the hatching base 19.

At least one hatching rib 5 of the hatching ribs has a height H of 0.1 mm to 0.8 mm, preferably of 0.2 mm to 0.5 mm, particularly preferably of 0.25 mm to 0.35 mm. The height H of a hatching rib 5 may be the height averaged along the longitudinal extent of the hatching rib. Heights may, as illustrated, be measured relative to the level 20 of the hatching base 19 of the hatched area 4. Mean values generally correspond to the arithmetic mean value.

The short transverse elevations 6 branching off from at least one hatching rib 5 of the hatching ribs each have mutually opposite flanks 14 which enclose an angle 15 of 2° to 10°, preferably of 6° to 8°, with one another. The mutually opposite flanks 14 enclose such an angle 15 here over a height extent which corresponds to at least one quarter of the height H of the respective hatching rib 5.

The exemplary embodiments illustrated in FIGS. 2 and 3 differ in particular in the angle 15, 15′ which the mutually opposite flanks 14 of the hatching ribs 5 enclose with one another.

The exemplary embodiment illustrated in FIG. 2 is characterized in that at least one hatching rib 5 of the hatching ribs has mutually opposite flanks 14 which enclose an angle 15′ of at least 50°, preferably of 55° to 65°, with one another. The exemplary embodiment further has flattened ridges, wherein the ridge lines 18, 24 run along the center of the ridges.

The exemplary embodiment illustrated in FIG. 3 is characterized in that at least one hatching rib 5 of the hatching ribs has mutually opposite flanks 14 which enclose an angle 15 of 2° to 10°, preferably of 6° to 8°, with one another.

FIG. 4 shows a schematic plan view of a hatched area 4 according to the invention. It may be the hatched area 4 illustrated in FIG. 2.

It can be clearly seen that all the short transverse elevations 6 branch off from the respective hatching rib 5 on the same first side 9 and end in a free end 8.

FIGS. 5a to 5g show examples of cross-sections of one of the hatching ribs 5 and/or of one of the short transverse elevations 6. The cross-section here runs in each case outside a branch 7 perpendicularly with respect to the longitudinal extent direction 12 of the respective short transverse elevation 6 or perpendicularly with respect to the longitudinal extent direction 10 of the respective hatching rib 5. The cross-sections are suitable for the hatched areas 4 illustrated in FIGS. 2 and 3. Without restricting the general nature, the cross-sections illustrated are symmetrical.

FIG. 5a shows a cross-section which has a linearly running region 16 in the region of the flanks 14. The flanks 14 lie opposite one another and may enclose an angle 15′ of at least 50°, preferably of 55° to 65°, with one another. The flanks 14 transition into the hatching base 19 in a bend.

FIG. 5b shows a corresponding cross-section, wherein the flanks 14 enclose an angle 15 of 2° to 10°, preferably of 6° to 8°, with one another. FIG. 5c shows by way of example that, irrespective of the exact configuration of the cross-section, the flanks 14 may also transition into the hatching base 19 with a curvature.

FIG. 5d shows a cross-section which has a convexly curved region 16 in the region of the flanks 14. FIG. 5e shows a cross-section which has a stepped region 16 in the region of the flanks 14.

FIG. 5f shows a cross-section which has a structured region 16 in the region of the flanks 14. FIG. 5g shows a cross-section which has a concavely curved region 16 in the region of the flanks 14.

In all the FIGS. 5a to 5g, the correspondingly shaped region 16 may extend over at least one quarter of the height H of the hatching rib of the corresponding hatching element.

The hatched areas 4 illustrated in FIGS. 1 to 5 of a surface 3,2 of a vehicle tire 1 may be produced by shape-imparting vulcanization of the vehicle tire. For this purpose, a vulcanization mold has a mold area which has a negative contour of the hatched area 4 to be created, in particular a negative contour of the respective hatched area 4 illustrated in one of FIGS. 1 to 5.

The production of a vehicle tire 1 having a surface 2,3, with a hatched area 4 as illustrated in FIGS. 1 to 5 comprises at least the following steps:
a) engraving a negative contour of the hatched area 4 into a mold area of a vulcanization mold for the shape-imparting vulcanization mold of a vehicle tire 1 by means of laser engraving, wherein the hatched area 4 has elongated hatching ribs which are arranged largely parallel to one another, wherein each hatching rib 5 has branches 7, wherein in each case precisely one short transverse elevation 6 branches off from each branch 7, and wherein the short transverse elevations 6 all branch off on a same first side 9 of the hatching ribs 5 and end in a free end 8,
b) providing a tire blank and positioning the tire blank in the vulcanization mold having the mold area,
c) shape-imparting vulcanization of the tire blank by means of the vulcanization mold having the mold area, as a result of which the hatched area 4 is imprinted into an outer area of the vehicle tire 1, in particular a sidewall 2 and/or a tread 3 of the vehicle tire 1.

The negative contour engraved into the mold area in step a) is here in particular a negative contour of one of the hatched areas 4 illustrated in FIGS. 1 to 5.

### LIST OF REFERENCE SIGNS

1 vehicle tire
2 sidewall
3 tread
4 hatched area
5 hatching rib
6 short transverse elevation
7 branch
8 free end
9 side
10 longitudinal extent direction of a hatching rib
11 angle
12 longitudinal extent direction of a short transverse elevation
13 clear spacing
14 mutually opposite flanks
15 angle
15′ angle
16 region
17 region
18 ridge line of a hatching rib
19 hatching base
20 level
21 third of height H
22 first center spacing of the branches
23 second center spacing of the hatching ribs
24 ridge line of a short transverse elevation
41 QR code
H height of a hatching rib
L length of a short transverse elevation

1.-15. (canceled)

16. A vehicle tire comprising:
first and second sidewalls;
a tread with at least one hatched area on at least one of the sidewalls and/or the tread, wherein the hatched area has elongated hatching ribs, which are arranged largely parallel to one another;
each hatching rib of the hatching ribs has branches, wherein in each case precisely one short transverse elevation branches off from each branch of the branches; and
the short transverse elevations branch off on a same first side of the hatching ribs and end in a free end.

17. The tire of claim 16, wherein the short transverse elevations (6) of at least one hatching rib (5) of the hatching ribs are arranged largely parallel to one another.

18. The tire of claim 16, wherein the branches (7) of at least one hatching rib (5) of the hatching ribs are arranged equidistantly.

19. The tire of claim 16, wherein the branches (7) of at least one hatching rib (5) of the hatching ribs and the branches (7) of a hatching rib (5) adjacent to the at least one hatching rib (5) are arranged offset to one another.

20. The tire of claim 16, wherein a longitudinal extent direction (10) of at least one hatching rib (5) of the hatching ribs encloses an angle (11) of 45° to 90°, preferably of 60° to 90°, particularly preferably of largely 90°, with the respective longitudinal extent direction (12) of the respective branching-off short transverse elevation (6).

21. The tire of claim 16, wherein the short transverse elevations (6) of at least one hatching rib (5) of the hatching ribs have a length L of 0.2 mm to 0.5 mm, preferably of 0.25 mm to 0.40 mm, particularly preferably of 0.25 mm to 0.32 mm.

22. The tire of claim 16, wherein the branches (7) of at least one hatching rib (5) of the hatching ribs have a first center spacing (22) of 0.2 mm to 0.4 mm, preferably of 0.25 mm to 0.30 mm.

23. The tire of claim 16, wherein the hatching ribs (5) are arranged with a second center spacing (23) of 0.4 mm to 1.0 mm, preferably of 0.5 mm to 0.7 mm, particularly preferably of 0.55 mm to 0.60 mm.

24. The tire of claim 16, wherein at least one hatching rib (5) of the hatching ribs has a height H of 0.1 mm to 0.8 mm, preferably of 0.2 mm to 0.5 mm, particularly preferably of 0.25 mm to 0.35 mm.

25. The tire of claim 16, wherein at least one hatching rib (5) of the hatching ribs has mutually opposite flanks (14) which enclose an angle (15′) of at least 50°, preferably of 55° to 65°, with one another.

26. The tire of claim 16, wherein at least one hatching rib (5) of the hatching ribs and/or at least one short transverse elevation (6) of the short transverse elevations has mutually opposite flanks (14) which enclose an angle (15) of 2° to 10°, preferably of 6° to 8°, with one another.

27. The tire of claim 16, wherein at least one hatching rib (5) of the hatching ribs and/or at least one short transverse elevation (6) of the short transverse elevations has a flank (14) which has a convexly curved and/or a linear and/or a concavely curved and/or a stepped and/or a bent and/or a structured region (16).

28. The tire of claim 16, wherein the vehicle tire (1) has several hatched areas (4) which are arranged in such a way that they represent a machine-readable code (41), preferably a two-dimensional code (41), particularly preferably a QR code (41).

29. A method for producing a vehicle tire, the method comprising:
engraving a negative contour of a hatched area (4) into a mold area of a vulcanization mold for the shape-imparting vulcanization mold of a vehicle tire (1) by means of laser engraving, wherein the hatched area (4) has elongated hatching ribs (5) which are arranged largely parallel to one another, wherein each hatching rib (5) of the hatching ribs has branches (7), wherein in each case precisely one short transverse elevation (6) branches off from each branch (7), and
wherein the short transverse elevations (6) all branch off on a same first side (9) of the hatching ribs and end in a free end (8);
providing a tire blank and positioning the tire blank in the vulcanization mold having the mold area; and
performing shape-imparting vulcanization of the tire blank by means of the vulcanization mold having the mold area, as a result of which the hatched area (4) is imprinted into an outer area of the vehicle tire, in particular a sidewall (2) and/or a tread (3) of the vehicle tire.
